(19) United States
(12) Patent Application Publication
(10) Pub. No.: US 2021/0214048 A1
(43) Pub. Date: Jul. 15, 2021

(54) SYSTEM AND METHOD FOR CONTROLLING A STRUCTURE SUSPENDED IN WATER

(71) Applicant: SUBSEA FARMING AS, Oslo (NO)

(72) Inventor: Oyvind Johnsen, Rykkin (NO)

(21) Appl. No.: 17/056,350

(22) PCT Filed: May 20, 2019
(86) PCT No.: PCT/NO2019/050111

§ 371 Date: Nov. 17, 2020

(30) Foreign Application Priority Data
May 18, 2018 (NO) 20180703

(51) Int. Cl. B63B 21/26; B63B 13/00; B63B 35/14; A01G 33/00; A01K 61/65

(52) U.S. Cl. CPC B63B 21/26; B63B 13/00; B63B 2021/003; A01G 33/00; A01K 61/65; B63B 35/14

(57) ABSTRACT

An aquatic system configured for suspending a structure (2; 9; 20; 21) in a body of water (W), comprising at least two buoyancy control arrangements (15) configured for connection to the structure (2; 9; 20; 21) and to a seabed (B) below the body of water (W). The structure (2; 9; 20; 21) is moored to the seabed (B) via the at least two buoyancy control arrangements (15). Each buoyancy control arrangement (15) comprising a first buoyancy device (4) and a second buoyancy device (3), the buoyancy of each of the first buoyancy devices (4) and each of the second buoyancy devices (3) is independently controllable in order to adjust the vertical and horizontal position of the structure (2; 9; 20; 21) and vertical and horizontal restoring capacity of the aquatic system in the body of water (W).

### FIELD OF THE INVENTION

The invention concerns the field of submerging structures, more particularly to a system for mooring one or more structures in a body of water, as set out by the preamble of claim 1, and to a method of controlling the vertical and horizontal position of a structure in a body of water, as set out by the preamble of claim 7.

### BACKGROUND OF THE INVENTION

Floating aquatic installations generally comprise a structure having one or more mooring lines which are connected to respective seabed anchors. As an example, a fishfarming plant comprises a net pen floating with its upper portion in, or immediately above, the water surface. The net pen is maintained in position by a plurality of mooring lines or/and chains. Such installations are subjected to wind and waves which may jeopardize operations and damage equipment. It is therefore a desire to develop arrangements that are more robust, whereby the installations may be placed farther out from shore.

One such arrangement is to submerge the installation in order to reduce impacts from the surf zone and extreme environmental loads at the surface. Submergence will also avoid impacts from biological and chemical environment that typically are present at or near the water surface, and mitigate or avoid operational aspects concerning security, obstruction of maritime surface activities, and unwanted visual impact to the surroundings.

The prior art includes TW 201112947 A, which discloses a net cage, a plurality of floats, a plurality of cable ropes, a plurality of buoys and a plurality of anchors. A buoy is arranged on the cable rope between the net cage and the seabed anchor. The buoy makes the cable rope generate tension force to act on the net cage so as to make the net cage generate horizontal force to resist a water current.

The prior art also includes U.S. Pat. No. 5,655,938 A, which discloses fish cage which is moored by two lines to respective seabed anchors. A float/ballast assembly, in which the buoyancy may be controlled, is incorporated into the mooring lines at two points on either side of the cage. The cage preferably has positive buoyancy which will allow it to float on the surface with some of its volume above water.

The prior art also includes JPH 11178474 A, which discloses a cage having buoyancy means and “deflectors” and being connected to seabed anchors by mooring wires. Submerged, buoys are connected to each wire. When the horizontal water currents increase, a downward force is generated by the deflectors, hence forcing the cage towards the seabed. When the water current subsides, the downward force subsides correspondingly, and the cage ascends towards the surface.

The prior art also includes KR 101185861 B1, which discloses a submersible fish cage comprising a cage body with a buoyancy controller. The buoyancy controller includes a buoyancy controlling tank having an empty space in the inside, a cover plate assembled to the upper side of the buoyancy controlling tank, a weight installed on the lower side of the buoyancy controlling tank, a sea water valve penetrating the bottom of the buoyancy controlling tank, and an air valve penetrating the cover plate. The air valve is connected to a control buoy having an air injection-discharge unit connected to an air hose. The buoyancy controller is connected to an upper pipe or a lower frame of the cage body. The cage is moored to seabed anchors via mooring lines suspended by surface buoys.

The prior art also includes JP 20100129552 A, KR 100925403 B1, KR 100270931 B1, KR 100885630 B1, RU 2105471 C1, JP 2016158516 A and EP 0076151 A2 which all disclose devices for submerging fish farming plants and cages.

The present invention provides improvement to the prior art, and offers also other advantages.

### SUMMARY OF THE INVENTION

The invention is set forth and characterized in the main claim, while the dependent claims describe other characteristics of the invention.

It is thus provided an aquatic system configured for suspending a structure in a body of water, comprising:
at least two buoyancy control arrangements configured for connection to the structure and to a seabed below the body of water, whereby the structure is moored to the seabed via the at least two buoyancy control arrangements;
each buoyancy control arrangement comprising a first buoyancy device and a second buoyancy device;
the buoyancy of each of the first buoyancy devices and each of the second buoyancy devices is independently controllable in order to adjust the vertical and horizontal position of the structure and vertical and horizontal restoring capacity of the aquatic system in the body of water.

The buoyancy of the first buoyancy device and the buoyancy of the second buoyancy device are independently controllable, whereby the buoyancy of the first buoyancy device may be greater than the buoyancy of the second buoyancy device, and vice versa.

In one embodiment, the at least two buoyancy control arrangements are connected to each other by a connection member.

In another embodiment, the connection member is configured to separate the structure from the first buoyancy device such that the first buoyancy device is positioned a distance away from the structure.

In another embodiment, the connection member forms a closed loop defining an opening for a structure to be positioned within.

In another embodiment, the buoyancy control arrangements are arranged at opposing sides of the connection member.

In another embodiment, the structure is a flexible structure like a net pen configured for fishfarming, or an elongated member configured for supporting a facility for growing seaweed or any other submerged facility, in which the buoyancy control arrangements maintain the shape of the flexible structure, fully or partially.

It is also provided a method of controlling the vertical and horizontal position of a structure in a body of water in an aquatic system. The method comprising controlling the buoyancy in said at least two buoyancy control arrangements in order to adjust the vertical and horizontal position of the structure in the body of water.

The net buoyancy may be controlled by controlling the net buoyancy of either or both the first buoyancy device or the buoyancy of the second buoyancy device. The buoyancy may be controlled by adding or removing water to/from a chamber inside the first and/or second buoyancy device.

The invention therefore provides a capability of supporting and operating a functional structure or facility in an aquatic environment, typically a marine offshore environment, at various levels of water depth, from the sea surface to an assigned submerged level, while maintaining the necessary structural integrity and horizontal and vertical restoring capacity of the overall system. This is achieved while the structure or facility is exposed to environmental loads from the marine environment as well as the dead weight and buoyancy of the structure and the overall system.

The structure may be a straight rope supporting a payload, e.g. for cultivating seaweed, a horizontal frame spread supporting a payload, e.g. a cage for fishfarming, or a volumetric structure (e.g. a tank for storage or other function), all with at least two oppositely arranged mooring and buoyancy control arrangements. The structure shall not be limited to the aforementioned examples, but may have other forms, shapes and functions.

The overall system has no parts or elements above the water surface when in the submerged state, thus disengaging it completely from potentially extreme weather conditions on the surface.

The system according to the invention may be configured in a straight line with sets of buoyancy devices (buoyancy control arrangements) at either end. It may also be configured similarly in a triangle or rectangle or square as well as a polygon, assumedly axi-symmetric. The system may carry any load or structure supported directly by the buoyancy devices or by the structure, or only in parts or marginally by the buoyancy devices by the structure being rigged or ballasted to close to neutrally buoyant state. The load or structure carried by the system may be single point loads or a system of loads from a larger integrated system or structure, e.g. a net or cage of an aquaculture facility. The latter typically applies to triangle, rectangle or any other polygon-shaped system. For these multisided systems, they will be supported by opposing pairs of buoyancy control arrangements, each having at least two buoys each.

### BRIEF DESCRIPTION OF THE DRAWINGS

These and other characteristics of the invention will become clear from the following description of a preferential form of embodiment, given as a non-restrictive example, with reference to the attached schematic drawings, wherein:

FIG. 1 is a schematic side view of an embodiment of the invented system, in a surface position;

FIG. 2 is a schematic side view of the embodiment illustrated in FIG. 1, illustrating the system in a submerged position;

FIG. 3 is an enlargement of the area “A” in FIG. 2;

FIG. 4 is a schematic side view of a second embodiment of the invented system, in a surface position;

FIG. 5 is a schematic side view of the embodiment illustrated in FIG. 4, illustrating the system in a submerged position;

FIG. 6 is an enlargement of the area “F” in FIG. 5;

FIG. 7 is a perspective view illustrating a variant of the embodiment of the invented system illustrated in FIGS. 4-6;

FIG. 8 is a schematic perspective view of an assembly of a plurality of the embodiment of the invented system illustrated in FIGS. 4-6;

FIG. 9 is a schematic perspective view of a third embodiment of the invented system;

FIG. 10 is a schematic side view of the embodiment illustrated in FIG. 9, in a surface position; and

FIG. 11 is a schematic side view of the embodiment illustrated in FIG. 10, illustrating the system in a submerged position.

FIGS. 12a-d are schematic side views illustrating a sequence of submerging a structure from the surface to the seabed.

FIG. 13 is a schematic side view of the aquatic system in a body of water where there is a current flowing from the left to the right in the figure.

FIG. 14 is a schematic side view of the aquatic system in a body of water where the centre of gravity of the structure has shifted.

FIG. 15 is a schematic perspective view of an aquatic system without a suspended structure.

### DETAILED DESCRIPTION OF A PREFERENTIAL EMBODIMENT

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

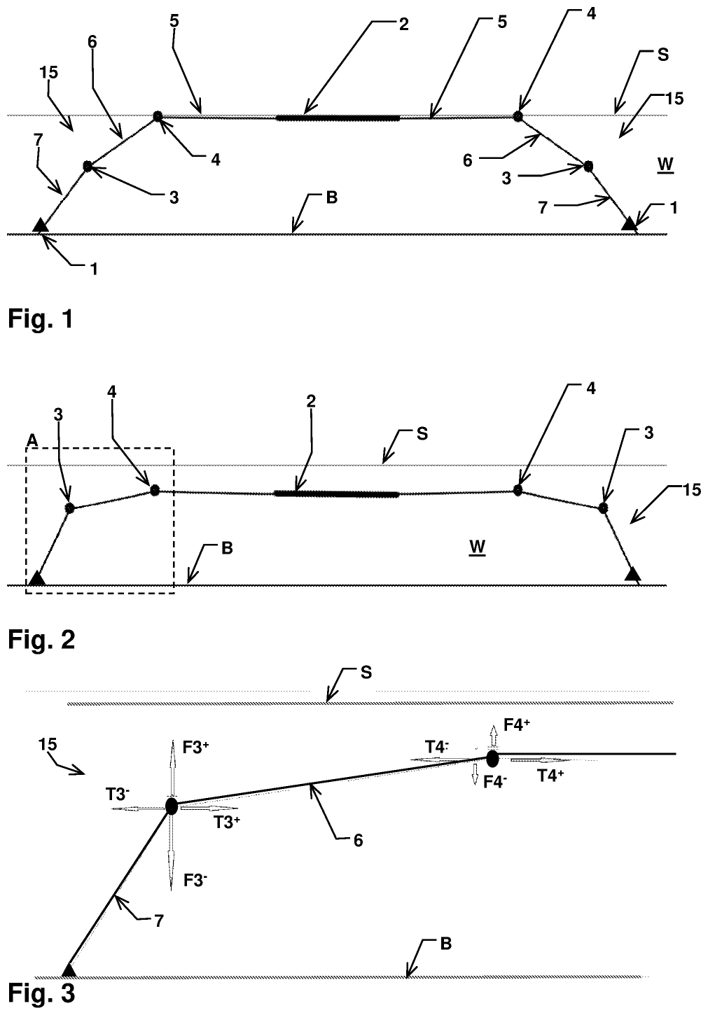

Referring initially to FIG. 1, the invented system comprises in the illustrated embodiment a structure 2 floating in the surface S of a body of water W. The structure 2 may be of a rigid or flexible constitution, have an elongated shape, circular shape or any other shape, and may comprise buoyancy elements (not shown).

In FIG. 1, the structure 2 is connected to—and moored to the seabed via—two oppositely arranged buoyancy control arrangements 15 via respective first connection members 5. The first connection member 5 may be flexible member (e.g. a tether, line, wire rope or other rope, chain, or rod) or a rigid member (e.g. a bar, beam). Each buoyancy control arrangement 15 comprises a first buoyancy device 4 and a second buoyancy device 3 interconnected via a second connection member 6. The second connection member 6 may be flexible member (e.g. a tether, line, wire rope or other rope, chain, or rod) or a rigid member (e.g. a bar, beam). The first buoy 4 is connected to the structure 2 via the aforementioned first connection member 5, while the second buoy 3 is connected to the seabed B via a third connection member 7. Although not illustrated, it should be understood that the first buoyancy device 4 may be connected directly to the structure 2, in which case the first connection member 5 is a bolt, rope, or other fastener known in the art. The third connection member 7 may be a flexible member (e.g. a tether, line, wire rope or other rope, chain, or rod) or a rigid member (e.g. a bar, beam). In the illustrated embodiment, the third connection member 7 is connected to the seabed via an anchor device 1.

The buoyancy control arrangements 15 are connected to opposing ends of the structure 2, and the buoyancy devices 4, 3 are kept together and tensioned up by the connection members and their respective connections to the seabed. The structure 2 is thus is supported—horizontally and vertically—by the buoyancy control arrangements 15.

The first and second buoyancy devices 4, 3 may be any buoys or buoyancy devices known in the art. The buoyancy in the first and second buoyancy devices 4, 3 are adjustable in a manner known in the art (e.g. as a buoy having a ballast chamber and associated valves and pumps for infusing and expelling water). The buoyancy devices 4, 3 may comprise a solid ballast with density significantly higher than water such that the buoyancy devices are capable having a sufficiently low net buoyancy and thereby sinking through ballasting, when the net buoyancy of the structure for example is close to zero.

In FIG. 2, the buoyancy of the first buoyancy devices 4 has been reduced (in a manner which per se is known, e.g. by adding a ballast), whereby the first buoyancy devices 4 and the structure 2 have been lowered to a submerged position below the water surface S. As indicated above, the reduction in buoyancy may be achieved by adding ballast (e.g. water) to the first buoyancy devices 4 and—optionally—by controlling ballast of the second buoyancy devices 3. In the state illustrated by FIG. 2, the second buoyancy devices 3 have become the main load-carrying devices for maintaining horizontal restoring forces, i.e. maintaining horizontal restoring forces in the system while the first buoyancy device 4 still controls a minimum of uplift for vertical restoring and for some structures also necessary load load-carrying. The first buoyancy devices 4 retain tension in the system and a (slight) positive buoyancy in order not to “freefall” sink with no upwards restoring capacity in itself or in the system.

A key principle of the invention is that the net buoyancy of the buoyancy control arrangements (i.e. in the first and/or the second buoyancy device 4, 3) is controllable in order to adjust the vertical position of the structure 2 in the body of water. The pair of buoyancy control arrangements 15 retain a system in tension by opposing forces and facilitates a stable submergence of the structure 2 and a stable operation of the structure at various levels in the water. In this context, “stable” means the maintaining of necessary horizontal and vertical restoring capacity to avoid excessive drift-off horizontally or progressive unstable sinking vertically. As such, the invented system is a mooring system which is capable of keeping the structure 2 in position horizontally but with the additional feature, compared to mooring systems of the prior art, of maintaining vertical hydrostatic stability during submergence operations and when in submerged state.

The structure 2 may be slightly positively buoyant, either inherently or in combination with auxiliary buoy. The pair of buoyancy control arrangements 15 are not necessarily and primarily intended for uplift for the structure, but is dedicated to creating stable restoring capacity horizontally and vertically. For some structures, the first buoyancy device 4 will also contribute with uplift or load-carrying capacity to the structure 2, either fully or partially. It will then typically be connected close to the structure, element 5 being very short or absent. An example is an aquaculture cage.

A fundamental principle of the invention is illustrated by the force couples in FIG. 3. In the illustrated example, the first buoyancy device 4 will always have a net upwards uplift (buoyancy). This maintains tension in the system (i.e. in the first, second and third connection members) even when the system is in a submerged state. As such, the system will not progressively sink downwards as it is submerged. The system still maintains its load carrying capabilities and position keeping capacity in the submerged position.

In general, the system according to the invention comprises the structure 2 interconnecting oppositely arranged buoyancy control systems 15. The structure will therefore oftentimes or normally only maintain its own structural integrity, not being directly exposed to loads induced in and on the structural frame, i.e. system pre-tension and environmental reactions. The system will therefore be self-contained and not be dependent on the structure to maintain structural integrity and stability. This enables easy installation, maintenance and refitting of parts or whole of the structure. Still the system will on a design level be dependent on the characteristics of the structure in terms of loading, dynamic response and stability. For some cases though, the structure could also be an integrated part of a more elaborate structural framework.

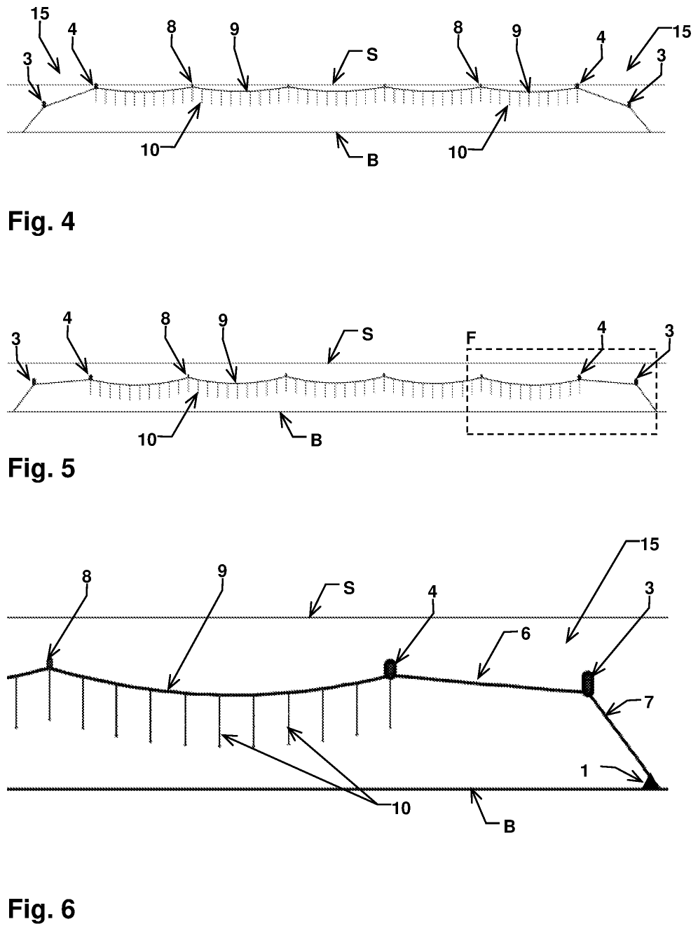

FIGS. 4-7 illustrate a second embodiment of the invented system. Unless otherwise noted, the features and aspects described above with reference to the first embodiment shall also apply to this second embodiment.

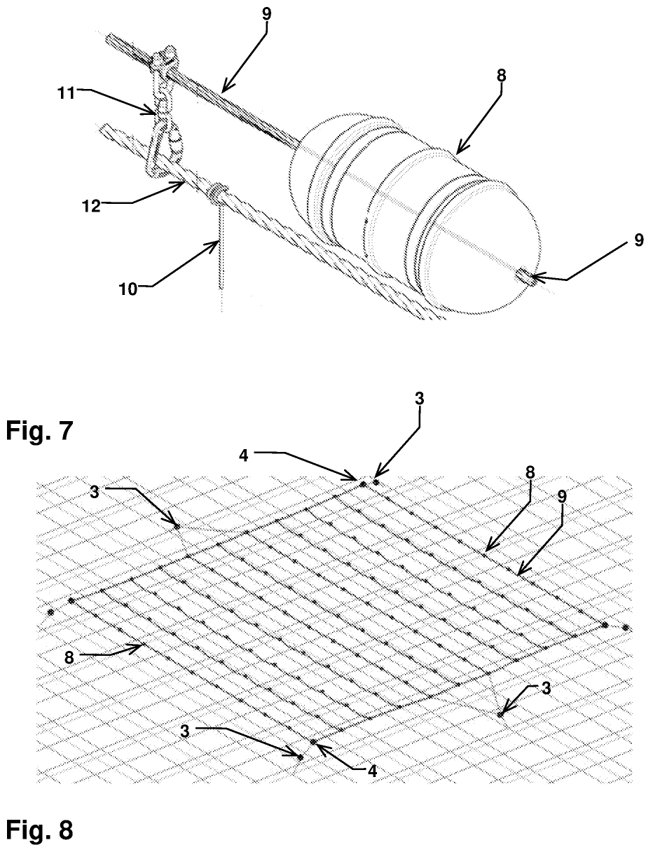

In the second embodiment of the invented system, the structure comprises an elongated member 9 which is connected to two buoyancy control arrangements 15 as described above. In the illustrated embodiment, the elongated member 9 is a rope, but the elongated member 9 may be any flexible member (e.g. a tether, line, wire rope or other rope, chain, or rod) or a rigid member (e.g. a bar, beam). Arranged at intervals along the elongated member 9 are auxiliary buoyancy devices 8, and a plurality of ropes 10 are suspended by and along the elongated member 9. A variant is shown in FIG. 7, in which the ropes 10 are attached to a secondary line 12, which in turn is connected to the elongated member (here: a rope or wire rope) 9 via a shackle 11. The secondary line 12 is not a part of the structural loading of the system. The auxiliary buoyancy devices 8 will tentatively make the structure neutrally buoyant. The ropes 10 may advantageously be used for growing and cultivating seaweeds. FIGS. 5 and 6 illustrate a submerged position for the system; corresponding in principle to the illustrations in FIGS. 2 and 3 as discussed above.

FIG. 8 illustrated how a plurality of systems according to the second embodiment of the invention (FIGS. 4-7) may interconnected to form an assembly of systems. It will be noted that for such multi-sided system, additional support on each side by buoyancy devices 4 may be desirable to maintain sideways restoring and efficient elevated shape of the system. These buoyancy devices 4 may or may not be ballastable, if not then just be a member following the active ballasting of the other buoyancy devices 4 actively ballasted.

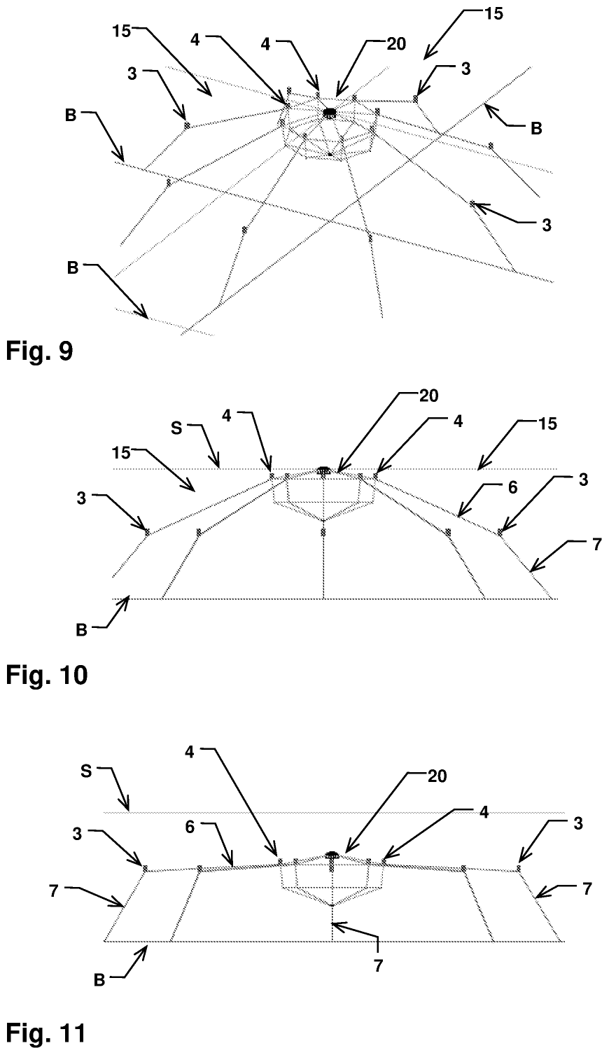

FIGS. 9-11 illustrate a third embodiment of the invented system. Unless otherwise noted, the features and aspects described above with reference to the first embodiment shall also apply to this third embodiment.

In the third embodiment of the invented system, the structure comprises a floating net pen 20 (for use in e.g. fish farming). The net pen 20 is moored to the seabed B by means of a plurality of buoyancy control arrangements 15 as described above (seabed anchors not shown). FIG. 9 shows an embodiment having eight buoyancy control arrangements 15, but it should be understood that fewer or more such arrangements may be used. Tension and structural integrity in the system is maintained independent of the nets; the net pen cage wire frame may be connected directly under the first buoyancy devices 4, whereby the first buoyancy devices will carry some or all of the payload of the net pen cage. It will be noted that in this embodiment, the first buoyancy devices 4 are connected directly to the net pen 20, and the aforementioned first connection member 5 has been omitted.

One additional beneficial aspect of this third embodiment, is that the fish inside the net pen may be kept below the lice zone, i.e. below 10-20 m. Remote access to the net pen from a vessel on the water surface is envisaged.

In the above descriptions of the embodiments of the invention, a distinction has generally been made between a first state (in which the structure is arranged in or above the water surface S) and a second state (in which the structure is fully submerged in the body of water). Common to all embodiments of the invention is that the net buoyancy of the buoyancy control arrangements (i.e. first and second buoyancy devices) may be controlled in order to adjust the vertical position of the structure in the body of water. As an example, the first state may be associated with a state in which the buoyancy of the first buoyancy device 4 is greater than the buoyancy of the second buoyancy device 3, while the second state may be associated with the state in which the buoyancy of the first buoyancy device 4 is less than the buoyancy of the second buoyancy device 3. It should be understood, however, that other buoyancy configurations are possible.

It should be understood that the invention is applicable for use in any aquatic environment, i.e. wherein the system is installed in a body of water.

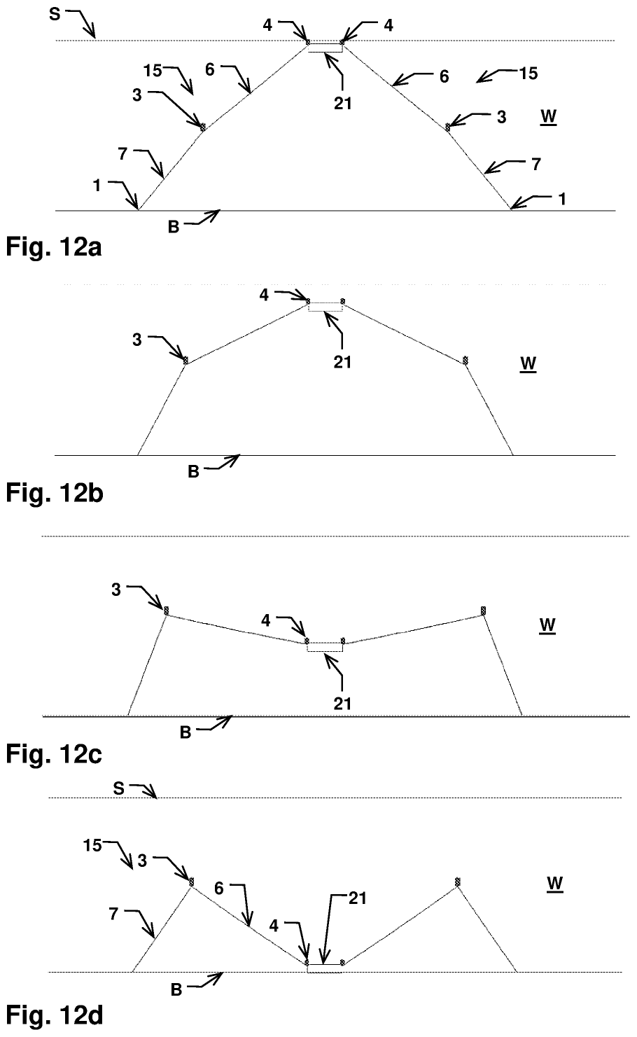

FIGS. 12a-d illustrate a sequence of submerging a structure 21. The structure 21 may be a subsea installation or part of such, a net pen, or any other payload adapted to be suspended in a body of water W. In the illustrated embodiment, the first buoyancy devices 4 are connected directly to the structure 21. The structure 21 may be moved from the first state at the surface S, as illustrated in FIG. 12a, to a location at the seabed B, as illustrated in FIG. 12d, and vice versa.

The buoyancy control arrangements 15 enable stable and controlled submergence of the structure 21 and lowering thereof through the body of water W all the way down to the seabed B. The aquatic system also provides stable and stationary steady state positioning of the structure 21 at any height in the body of water W. As such the aquatic system is provided for submergence, lowering and rising the structure 21, as well as for steady maintenance of a structure 21 at a defined submergence level over time. The aquatic system is configured for suspending a structure 21 in a body of water W. It is a position keeping—and regulating system as well as a payload carrying system serving as the buoyancy of the structure in parts or fully to keep the structure 21 both afloat and hydrostatically stable in a submerged position.

The buoyancy control arrangements 15 have the capacity to regulate the vertical position of the structure 21 in the water W primarily by regulating the buoyancy of first buoyancy devices 4, and indirectly also by regulating buoyancy of second buoyancy devices 3. The aquatic system also has the capacity to regulate horizontal position of the structure 21, primarily by regulating the buoyancy of the second buoyancy devices 3 individually between one buoyancy control arrangement 15 and another.

Intrinsic to the system is also the capacity to regulate stiffness or restoring capacity of itself, primarily by regulating the buoyancy of the second buoyancy devices 3. Stiffness is defined as movement resulting from a given load, that is the derivative of movement versus load. Load for this system could be horizontal load on the structure 21 from the environment or a vertical load on the structure 21 resulting from ballasting of the first buoyancy devices 4.

A practical impact of regulating the stiffness is the possibility to reduce horizontal movement of the structure to sea current loading or other steady environmental loading, by increasing buoyancy of second buoyancy devices 3. Another practical impact is the possibility to reduce the amount of ballasting required of the first buoyancy devices 4, to move the structure 21 vertically in the water column by reducing the buoyancy of second buoyancy devices 3, for example for surfacing the structure. By regulating stiffness, dynamic properties and resonance periods may also be adjusted and controlled, to improve response of the system to dynamic loading such as ocean waves. This active regulation of stiffness is different from conventional position keeping systems and ballasting or floatation systems on floating units, for which stiffness, horizontal or vertical, cannot be actively regulated.

The operative features and capacities for the specific applications of the aquatic system may depend on geometrical properties such as length of the connection members 6 and 7 and distance between opposing seabed anchors 1 versus given water depth and horizontal extent of structure 21 and member 5. It may also depend on load balance: Buoyancy of the first and second buoyancy devices 4, 3, and their buoyancy regulation capacity versus the weight of the structure 21.

In FIG. 12a, the first buoyancy devices 4 may be in a state of maximum, or close to maximum, net buoyancy. The second buoyancy devices 3 are, however, at a reduced net buoyancy compared to its maximum, in order to reduce vertical restoring stiffness and thereby enabling surfacing of structure 21 with less regulation of ballast of the first buoyancy devices 4. As such, the second connection member 6 and third connection member 7 may more easily become extended and parallel, and the maximum height of the structure 21 above the seabed B is achieved. The structure 21 is in the illustrated embodiment at a location at the surface S. The second connection member 6 separates the first and second buoyancy devices 3, 4, and the third connection member 7 separates the second buoyancy device 3 from the seabed B. The third connection member 7 is configured for connection to the anchor device 1.

In FIG. 12b, both the first and second buoyancy devices 4,3 may be in a state of maximum net buoyancy. Instead of a maximum buoyancy state, the state indicated in FIG. 12b may also correspond to a state in which the first and second buoyancy devices 4,3 have a corresponding buoyancy. The structure 21 is thus kept in a controlled, intermediate state.

In FIG. 12c, the first buoyancy devices 4 may have a positive buoyancy, but the net buoyancy of the structure 21 and the first buoyancy devices 4 is negative when the first buoyancy devices 4 are positioned lower (in a vertical direction) than the second buoyancy devices 3. The second buoyancy devices 3 have a positive net buoyancy, and the vertical position of the structure 21 in the body of water W is controlled.

In FIG. 12d, the structure 21 is placed at the seabed B, and the first buoyancy devices 4 and structure 21 may have a negative net buoyancy in order to provide the structure 21 safely on the seabed B. The buoyancy in the buoyancy devices 3 may be slightly positive to keep the connection members 6,7 straight and prevent them from getting entangled on the seabed B.

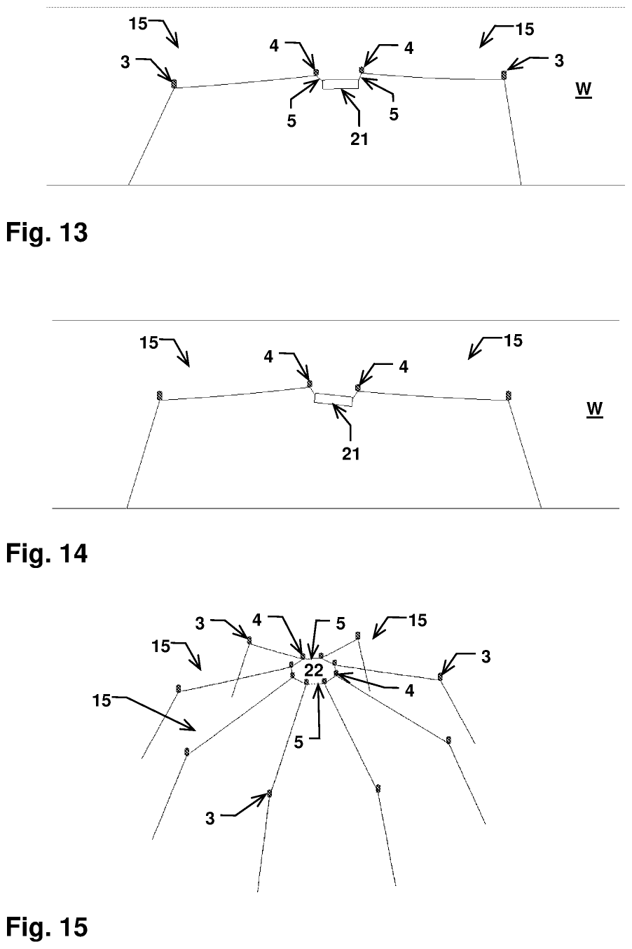

FIG. 13 illustrates the aquatic system in a body of water W where there is a current flowing from the left to the right in the figure. Such a current may be due to shifting tides, or other environmental forces. The first buoyancy devices 4 are in the illustrated embodiment connected to each other and to the structure 21 by connection members 5. Because of the current, the buoyancy control arrangements 15 and the structure 21 are forced towards a skewed position downstream of the current. In FIG. 13 this skewed position is towards the right.

In order to counteract a skewness of the aquatic system, the second buoyancy device 3 to the left in FIG. 13 may be provided with a greater buoyancy than the second buoyancy device 3 to the right in the figure. As such, the left buoyancy control arrangement 15 in FIG. 13 will induce higher tension on the structure than the right buoyancy control arrangement 15 until the structure is in neutral position closer to the original position before current. As such the aquatic system will reduce or fully counteract offset/skewd position resulting from current loading, or in other words form a position that is less skewed than if the second buoyancy devices 3 of both control arrangements 15 had a corresponding buoyancy. This principle is also applicable for aquatic systems comprising more than two control arrangements 15. Several first buoyancy devices 4 may be provided with different buoyancy in order to prevent horizontal skewness of a system.

FIG. 14 illustrates the aquatic system in a body of water W where the COG (centre of gravity) of the structure 21 has shifted, such that the structure 21 is no longer suspended horizontally. This may be due to planned or accidental change in loading on or within the structure 21, etc. In FIG. 14, the right hand side of the structure 21 is illustrated as being heavier or with less buoyancy, and the right hand side of the structure 21 is thus positioned lower than the left hand side.

To counteract this type of non-horizontal alignment of the structure 21, the first buoyancy device 4 closest to the side or portion of the structure 21 being in the lower position may be provided additional buoyancy in order for the structure 21 to horizontally aligned again. This principle is also applicable even though there are more than two control arrangements, and as such several first buoyancy devices 4 may be provided with different buoyancy, in order to horizontally stabilize any structure 21.

FIG. 15 illustrates an aquatic system without a suspended structure in the centre. The aquatic system in the illustrated embodiment comprises eight buoyancy control arrangements 15, each comprising first buoyancy devices 4 and second buoyancy devices 3. This embodiment is similar to the embodiment of FIG. 9-11, without the net pen. The buoyancy control arrangements 15 may be connected to each other by connection members 5, such that when the aquatic system does not hold or suspend a structure, the aquatic system may still have structural integrity. The connection members 5 may as such form a closed loop that defines an opening 22, as in the illustrated embodiment. An arrangement with connection members 5 arranged in this way removes the direct loading from the system onto the structure, for which the structure becomes a module to be attached to the system. The aquatic system serves directly as a mooring system with payload carrying capacity for the structure. A structure to be suspended in a body of water can easily be accommodated in the opening 22. The connection members 5 may even be stiff members, and the closed loop may be formed by one stiff connection member 5, in order to provide for easy positioning of a structure in the opening 22.

1. An aquatic system configured for suspending a structure (2; 9; 20;
21) in a body of water (W), comprising:
at least two buoyancy control arrangements (15) configured for connection to the structure (2; 9; 20; 21) and to a seabed (B) below the body of water (W), whereby the structure (2; 9; 20; 21) is moored to the seabed (B) via the at least two buoyancy control arrangements (15);
each buoyancy control arrangement (15) comprising a first buoyancy device (4) and a second buoyancy device (3);
the buoyancy of each of the first buoyancy devices (4) and each of the second buoyancy devices (3) is independently controllable in order to adjust the vertical and horizontal position of the structure (2; 9; 20; 21) and vertical and horizontal restoring capacity of the aquatic system in the body of water (W).

2. The aquatic system of claim 1, where the at least two buoyancy control arrangements (15) are connected to each other by a connection member (5).

3. The aquatic system of claim 2, where the connection member (5) is configured to separate the structure (2; 9; 20; 21) from the first buoyancy device (4) such that the first buoyancy device (4) is positioned a distance away from the structure (2; 9; 20; 21).

4. The aquatic system of claim 2, where the connection member (5) forms a closed loop defining an opening (22) for a structure (21) to be positioned within.

5. The aquatic system of claim 2, wherein the buoyancy control arrangements (15) are arranged at opposing sides of the connection member (5).

6. The aquatic system of claim 1, wherein the structure is a flexible structure like a net pen (20) configured for fishfarming, or an elongated member (9) configured for supporting a facility (10, 12) for growing seaweed or any other submerged facility, in which the buoyancy control arrangements (15) maintain the shape of the flexible structure, fully or partially.

7. A method of controlling the vertical and horizontal position of a structure (2; 9; 20; 21) in a body of water (W) in an aquatic system as set out by claim 1; comprising controlling the buoyancy in said at least two buoyancy control arrangements (15) in order to adjust the vertical and horizontal position of the structure (2; 9; 20; 21) in the body of water.

8. The method of claim 7, wherein the net buoyancy is controlled by controlling the net buoyancy of either or both the first buoyancy device (4) or the buoyancy of the second buoyancy device (3).

9. The method of claim 8, wherein the buoyancy is controlled by adding or removing water to/from a chamber inside the first and/or second buoyancy device.
